(19) United States
(12) Patent Application Publication
(10) Pub. No.: US 2022/0324223 A1
(43) Pub. Date: Oct. 13, 2022

(54) INKJET PRINTING APPARATUS AND PRINT METHOD

(71) Applicant: CANON KABUSHIKI KAISHA, Tokyo (JP)

(72) Inventors: Hajime Nagai, Kanagawa (JP); Yuji Konno, Kanagawa (JP); Satoshi Wada, Tokyo (JP); Naoko Baba, Kanagawa (JP); Shingo Nishioka, Kanagawa (JP); Kei Yoshizawa, Kanagawa (JP); Junichi Saito, Kanagawa (JP); Serena Yoshikawa, Kanagawa (JP)

(21) Appl. No.: 17/709,530

(22) Filed: Mar. 31, 2022

(30) Foreign Application Priority Data
Apr. 8, 2021 (JP) 2021-065728

(51) Int. Cl. B41J 2/045; B41J 11/00

(52) U.S. Cl. CPC B41J 2/0451; B41J 11/0095; B41J 2/04586

(57) ABSTRACT

An inkjet printing apparatus is configured to print the image in N (N is an integer of four or more) print scanning operations of a print head for a unit region of the print medium by using N mask patterns used in the N print scanning operations. The inkjet printing apparatus includes: an obtaining unit configured to obtain defective nozzle information specifying a defective nozzle; and a correction unit configured to divide the N mask patterns into mask groups each corresponding to two or more print scanning operations and correct the mask patterns based on the defective nozzle information in each of the divided mask groups.

### BACKGROUND OF THE INVENTION

### Field of the Invention

The present invention relates to a technique of print control in an inkjet printing apparatus.

### Description of the Related Art

There is an inkjet printing apparatus that performs printing of a predetermined unit region in multiple print scanning operations (hereinafter, referred to as multipass). It is known that, in the case where one or more ejection defective nozzles are identified in such an inkjet printing apparatus, a print mask data used for multipass printing is corrected. Japanese Patent Laid-Open No. 2000-094662 (hereinafter, referred to as Literature 1) discloses processing (hereinafter, referred to as non-ejection complementary processing) of correcting the print mask data such that printing is performed by using, instead of the ejection defective nozzles, normal nozzles capable of performing printing of the same region as the region which the ejection defective nozzles are in charge of.

Japanese Patent Laid-Open No. 2006-044060 (hereinafter, referred to as Literature 2) discloses a technique in which a trailing edge of a print medium is detected and a conveyance amount of the print medium is changed depending on the detection result while a range of nozzles to be used is shifted.

In the non-ejection complementary processing described in Literature 1, in the case where the nozzles to perform printing of the same region as the region which the ejection defective nozzles are in charge of are not determined, there is a possibility that the print mask data cannot be appropriately corrected. For example, in the case where the conveyance amount of the print medium is changed depending on the detection timing of the trailing edge of the print medium as in Literature 2, nozzles in charge of printing of each of regions vary depending on the detection timing of the trailing edge. In such a case, there is a possibility that the non-ejection complementary processing is not appropriately performed.

### SUMMARY OF THE INVENTION

An inkjet printing apparatus according to one aspect of the present invention includes: a conveyance unit configured to convey a print medium in a conveyance direction; a print head configured to have a nozzle row in which nozzles configured to eject ink are arranged in the conveyance direction; a detection unit configured to detect a trailing edge of the print medium conveyed by the conveyance unit; a control unit configured to print an image by controlling a usage range of the nozzle row in the conveyance direction and a conveyance amount of the print medium after detection of the trailing edge, based on a detection result of the detection unit, the image printed in N (N is an integer of four or more) print scanning operations of the print head for a unit region of the print medium by using N mask patterns used in the N print scanning operations; an obtaining unit configured to obtain defective nozzle information specifying a defective nozzle; and a correction unit configured to divide the N mask patterns into mask groups each corresponding to two or more print scanning operations and correct the mask patterns based on the defective nozzle information in each of the divided mask groups.

Further features of the present invention will become apparent from the following description of exemplary embodiments with reference to the attached drawings.

### BRIEF DESCRIPTION OF THE DRAWINGS

FIG. 1 is a block diagram illustrating a schematic configuration of a print control system in a printing apparatus;

FIG. 2 is a perspective view illustrating the printing apparatus;

FIG. 3 is a schematic diagram illustrating a configuration around a print head;

FIG. 4 is a diagram illustrating a nozzle row configuration of the print head;

FIG. 5 is a diagram illustrating a block configuration of a print control unit;

FIG. 6 is a diagram explaining a conveyance amount of a print medium and positions of the nozzles to be used;

FIGS. 7A and 7B are diagrams illustrating examples of mask patterns;

FIGS. 8A to 8C are diagrams explaining the conveyance amount of the print medium and the positions of the nozzles to be used around a trailing edge detection portion;

FIG. 9 is a flowchart of print control for one band region;

FIGS. 10A to 10C are diagrams explaining mask pattern correction; and

FIG. 11 is a flowchart of print control for one band region.

### DESCRIPTION OF THE EMBODIMENTS

Embodiments of the present invention are described below with reference to the attached drawings. Note that the following embodiments do not limit the present invention according to the scope of claims and not all of combinations of characteristics described in the embodiments are necessary for solving means of the present invention. Note that the same components are denoted by the same reference numerals and description thereof is omitted.

### First Embodiment

### <Configuration of Inkjet Printing Apparatus>

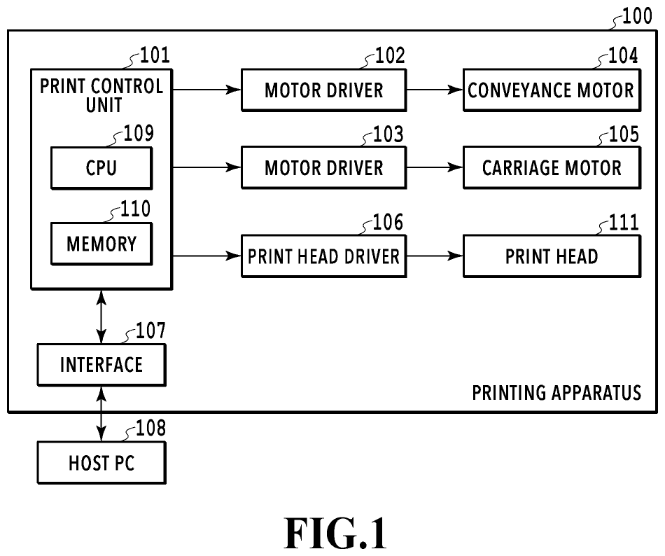

FIG. 1 is a block diagram illustrating a schematic configuration of a print control system of an inkjet printing apparatus (hereinafter, simply referred to as printing apparatus) in the present embodiment. The printing apparatus 100 includes a print control unit 101, a motor driver 102, a motor driver 103, a conveyance motor 104, a carriage motor 105, a print head driver 106, an interface 107, and a print head 111.

The printing apparatus 100 is connected to an external host computer (host PC) 108 via the interface 107 such that the printing apparatus 100 and the host PC 108 are communicable with each other. The host PC 108 is a data supply apparatus and transmits image data to be printed, control commands, and the like to the printing apparatus 100. Various pieces of data, the control commands, and the like transmitted from the host PC 108 are inputted into the print control unit 101 of the inkjet printing apparatus 100.

The print control unit 101 controls a print unit (printer engine) such as the print head 111 to perform printing based on the inputted image data. Moreover, the print control unit 101 performs various image processes (color space conversion, resolution conversion, binarization process, and the like) for converting the image data transmitted from the host PC 108 to data for printing. The print control unit 101 includes a memory 110 that stores mask patterns to be described later, a CPU 109 (may be an ASIC), a ROM, and a RAM. The CPU 109 integrally controls the units of the printing apparatus 100 and, for example, controls the motor drivers 102 to 103 and the print head driver 106 according to a control command inputted via the interface 107.

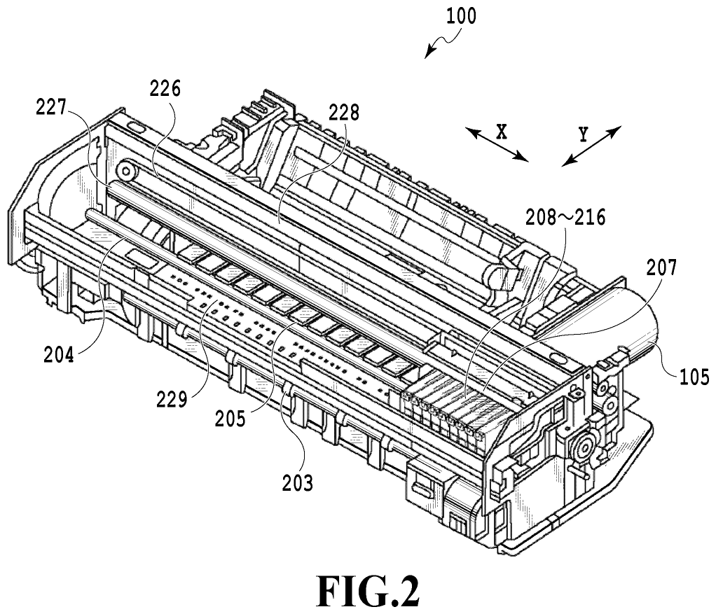

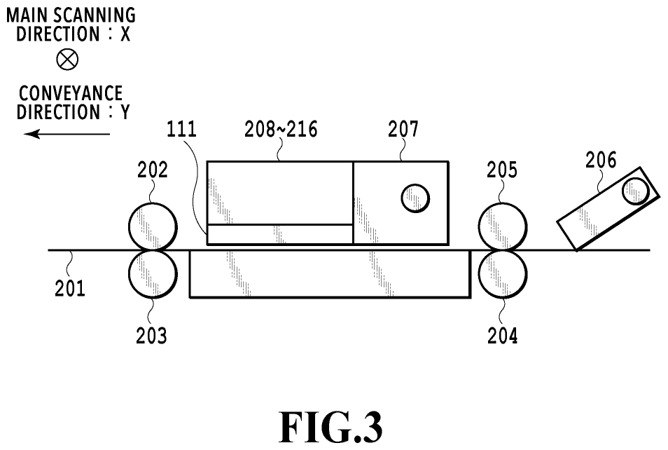

The conveyance motor 104 is a conveyance motor that rotates an upstream conveyance roller 204 and a downstream conveyance roller 202 that convey a print medium 201 such as a print sheet (for both rollers, see FIG. 3). The carriage motor 105 is a carriage motor that reciprocates a carriage 207 (see FIGS. 2 and 3) on which the print head 111 is mounted, in a main scanning direction. In this case, the main scanning direction is a direction intersecting a conveyance direction of the print medium 201. The motor drivers 102 and 103 are drivers that drive the conveyance motor 104 and the carriage motor 105, respectively.

The print head driver 106 is a driver that drives the print head 111 and a plurality of the print head drivers 106 may be provided to correspond to the number of print heads. The print head driver 106 includes, for example, various control circuits such as a selector and a decoder for controlling voltage supplied to heaters provided for nozzles. The print control unit 101 and the print head driver 106 are connected to each other by, for example, a flexible cable.

FIG. 2 is a perspective view illustrating the printing apparatus 100. The printing apparatus 100 according to the present embodiment is formed of a feed unit configured to feed the print medium (sheet), a conveyance unit configured to convey the print medium, a print unit configured to print an image on the print medium, a discharge unit configured to discharge the print medium on which the image is printed, a recovery unit configured to recover a print performance of the print unit, and the like.

The feed unit includes a feed tray on which multiple print media are stacked and a feed roller that feeds the print media stacked on the feed tray one by one to a printing apparatus interior. The conveyance unit includes the upstream conveyance roller 204 that conveys each print medium fed from the feed unit and an upstream auxiliary roller 205 that nips the print medium together with the upstream conveyance roller 204.

The print unit includes the print head 111 (not illustrated in FIG. 2) that is provided with nozzles configured to eject inks and ink tanks 208 to 216 that supply the inks to the print head 111. Moreover, the print unit includes the carriage 207 on which the print head 111 and the ink tanks 208 to 216 are attachably and detachably mounted. The carriage 207 is configured to be capable of being reciprocated by drive of the carriage motor 105 in a direction X (main scanning direction) along a guide shaft 227 via a timing belt 226 attached to a chassis 228. The print medium is conveyed in a direction Y (conveyance direction) intersecting the main scanning direction. A platen 229 that supports the print medium from below is provided at a position facing the print head 111 such that the distance between a surface of the print medium and a nozzle surface of the print head 111 is maintained constant. The discharge unit includes the downstream conveyance roller 202 (see FIG. 3) that discharges the print medium on which the image is printed to the outside of the printing apparatus and an auxiliary roller 203 that nips the print medium together with the downstream conveyance roller 202.

FIG. 3 is a schematic diagram illustrating a configuration around the print head 111 in the printing apparatus 100 of the present embodiment. The print head 111 mounted on the carriage 207 of the present embodiment is a print head that performs printing by ejecting ink droplets of nine colors (black, cyan, magenta, yellow, gray, photo cyan, photo magenta, red, and green). The print head 111 includes nozzles rows that eject the ink droplets of the respective colors. The ink tanks 208 to 216 are configured to contain the inks of nine colors, respectively, and to be capable of supplying the inks of nine colors to the corresponding nozzle rows in the print head 111.

The print medium 201 is nipped by the upstream conveyance roller 204 and the upstream auxiliary roller 205. Moreover, the print medium 201 is nipped by the downstream conveyance roller 202 and the auxiliary roller 203 that are located downstream of the print head 111 in the conveyance direction. The upstream conveyance roller 204 and the downstream conveyance roller 202 synchronously rotate and convey the print medium. A paper edge detection sensor (hereinafter, referred to as PE sensor) 206 is capable of detecting presence or absence of the print medium by using an angle of a lever.

The ink tanks 208 to 216 and the print head 111 can be mounted on the carriage 207 and the carriage 207 is configured to be capable of being reciprocated in the main scanning direction X with the print head and the ink tanks mounted thereon. Ejecting the ink droplets from the nozzles of the print head 111 during the reciprocation of the carriage 207 causes an image to be printed on the print medium 201.

In the case where the print head 111 receives a print start command, the print head 111 prints an image on the print medium 201 by ejecting the ink droplets while moving in the main scanning direction X together with the carriage 207. In one movement (scanning) operation of the print head 111, printing is performed on a region having a width corresponding to a nozzle arrangement range (arranged in a direction intersecting the main scanning direction X) of the print head 111. In the case where the printing performed with one scanning operation of the carriage 207 in the main scanning direction X is completed, the upstream conveyance roller 204 and the downstream conveyance roller 202 rotate before start of the subsequent print scanning operation and the print medium 201 is conveyed in the conveyance direction Y intersecting the main scanning direction X. An image is printed on the entire surface of the print medium 201 by repeating the print scanning operation of the print head 111 and the conveyance of the print medium 201 as described above. The print control unit 101 controls the print head driver 106 to perform an ejection operation of ejecting the ink droplets from the nozzles of the print head 111.

Note that, in the aforementioned example, the configuration in which the ink tanks 208 to 216 and the print head 111 that are separable are mounted on the carriage 207. However, there may be employed a mode in which a cartridge in which the ink tanks 208 to 216 and the print head 111 are integral is mounted on the carriage 207. Moreover, there may be employed a mode in which a multi-color integral print head capable of ejecting inks of multiple colors from one print head is mounted on the carriage 207.

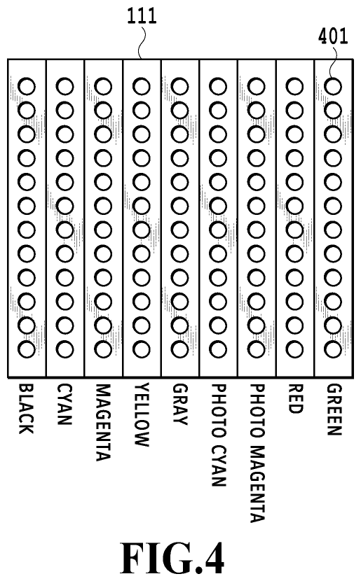

FIG. 4 is a diagram illustrating an example of a nozzle row configuration in the print head 111. Nozzles 401 illustrate the nozzles that eject the ink droplets and 12 nozzles are arranged in a row in a sub scanning direction in the nozzle row of each color in the print head 111. Moreover, the nozzle rows of the respective colors are arranged in the main scanning direction. Although the number of nozzles and the number of nozzle rows are determined as illustrated in FIG. 4 in the present embodiment, the number of nozzles and the number of nozzle rows do not have to be those illustrated in FIG. 4.

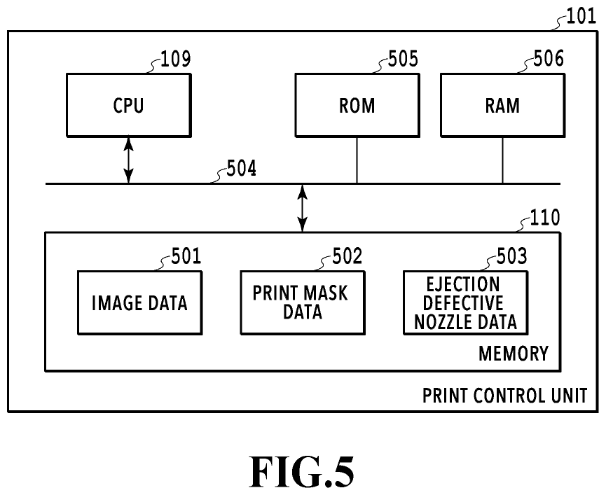

FIG. 5 is a diagram illustrating a block configuration according to print mask control of the print control unit 101. The CPU 109 and the memory 110 are connected to each other via a bus 504. Image data 501 to be printed, mask patterns 502 to be described later, and ejection defective nozzle data 503 are stored in the memory 110. The CPU 109 reads the aforementioned pieces of data from the memory 110 and corrects the mask patterns 502 depending on ejection defective nozzles. A ROM 505 stores a program and the like executed by the CPU 109. A RAM 506 is used as a working memory of the CPU 109. The CPU 109 reads the program stored in the ROM 505 and executes the program to implement operations of each embodiment.

Next, conveyance control and print control in the present embodiment are described. First, a kicking-away operation is described by using FIG. 3. The kicking-away operation is an operation of conveyance control in which a trailing edge of the print medium is detected and a conveyance amount of the print medium is changed depending on a detection result. Moreover, in this case, print control is performed such that a range of nozzles to be used is shifted.

Assume a case where the trailing edge of the print medium 201 stops at a nip portion (hereinafter, referred to as nip portion A) of the upstream conveyance roller 204 and the upstream auxiliary roller 205. In this case, in the next conveyance operation, the print medium trailing edge receives pushing-out force from the two rollers. As a result, the conveyance accuracy decreases. In order to prevent this, the conveyance control is performed not to stop the print medium trailing edge at the nip portion A. Specifically, a conveyance operation in which the print medium trailing edge reaches a predetermined range around the nip portion A is determined from the detection result of the PE sensor 206 and the conveyance amount in the determined conveyance operation is increased from a normal conveyance amount. Performing control based on the detection result of the PE sensor 206 enables determination of the conveyance operation in which the trailing edge reaches the predetermined range, irrespective of, for example, differences in size (length in the conveyance direction) of the print medium, individual differences among print media of the same size, or the like. An operation of increasing the conveyance amount of the print medium around the nip portion A and causing the print medium trailing edge to pass the nip portion A without stopping around the nip portion A as described above is referred to as kicking-away operation. Moreover, the image is printed while the nozzles to be used in the print scanning operation are shifted by an amount corresponding to the increase in the conveyance amount. Specifically, since the print medium is located downstream of that in the normal state in the conveyance direction, the nozzles to be used are shifted to the nozzles located downstream of the nozzles set to be used before the kicking-away operation, in the conveyance direction of the print medium in the print head 111. Specifically, the usage range of the nozzle rows is changed. The subsequent conveyance is performed by rotation of the downstream conveyance roller 202. Image printing including the kicking-away operation as described above is performed while the conveyance amount of the print medium and the nozzles to be used in the print scanning operation are shifted depending on the position of the print medium in a conveyance route.

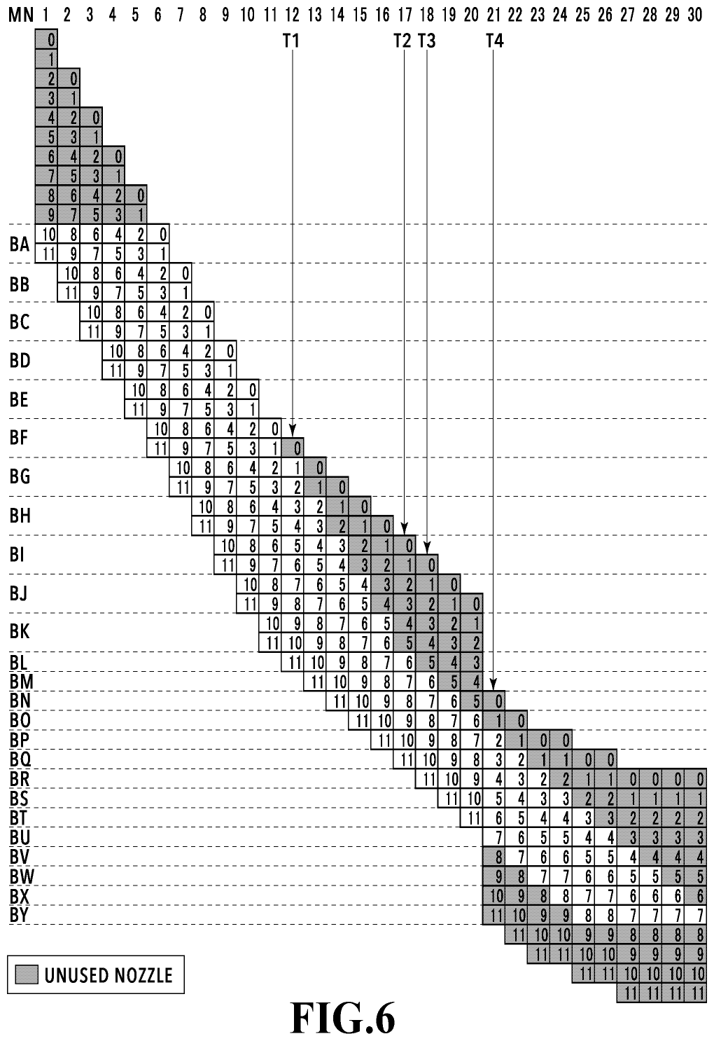

FIG. 6 is a diagram explaining the positions of the nozzles to be used and a positional relationship of the print head (conveyance amount of the print medium) relative to the printing medium in each print scanning operation in six-pass printing. The conveyance control and the print control relating to the aforementioned kicking-away operation are specifically described by using FIG. 6. In FIG. 6, the conveyance amount of the print media is expressed as an amount of movement of the print head relative to the print medium for the sake of explanation. Specifically, the page of FIG. 6 illustrates an example in which the print medium is conveyed from the bottom of the page to the top of the page. Moreover, description is given while focusing on arbitrary one of the multiple nozzle rows. In FIG. 6, shaded portions illustrate nozzles that do not participate in printing and nozzles in not-shaded portions illustrate nozzles used for printing in the corresponding print scanning operations. Numbers of 0, 1, 2, . . . , 10, and 11 are set for the respective nozzles of the print head 111 from the downstream side in the conveyance direction. Moreover, hereinafter, the nozzle with the nozzle number of 1 is referred as “nozzle 1”. The same applies to the other nozzle numbers. In FIG. 6, “MN” indicates “main scanning operation number.” “BA” to “BY” indicate “band region A” to “band region Y”, respectively. “T1” indicates “start of nozzle shift before kicking-away.” “T2” indicates “completion of nozzle shift before kicking-away.” “T3” indicates “trailing edge detection by PE sensor.” “T4” indicates “execution of kicking-away operation.”

First, from the start of printing to the eleventh print scanning operation, the image printing proceeds while repeating the print scanning operation and the conveyance operation of the print medium in which the conveyance amount in one operation is an amount corresponding to two nozzles.

In each of band regions (band regions A to F) in which the six-pass printing is completed before the twelfth print scanning operation (that is at the point of completion of the eleventh print scanning operation), the printing is performed by using the following nozzles. Specifically, the printing of the first to sixth passes is performed by using nozzle 10 and nozzle 11 in the first pass, nozzle 8 and nozzle 9 in the second pass, nozzle 6 and nozzle 7 in the third pass, nozzle 4 and nozzle 5 in the fourth pass, nozzle 2 and nozzle 3 in the fifth pass, and nozzle 0 and nozzle 1 in the sixth pass. In the printing of each of the six passes, the printing is performed while thinning the image by using a mask pattern set for the corresponding pass.

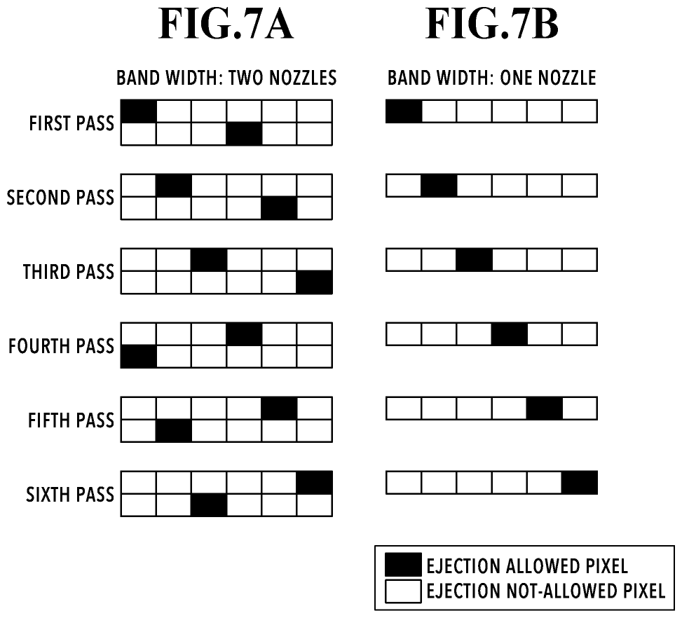

FIGS. 7A and 7B are examples of the mask patterns. FIG. 7A illustrates mask patterns for the case where a bandwidth is two nozzles. FIG. 7B illustrates mask patterns for the case where the bandwidth is one nozzle. The mask pattern to be applied is selected according to the bandwidth of each band. In FIGS. 7A and 7B, black pixels indicate pixels for which ejection is allowed. The mask patterns of the respective passes are patterns in a complementary relationship with one another and are such patterns that image printing is completed in the case where images printed in six passes are laid one on top of the other.

Description continues by returning to FIG. 6. In the twelfth to seventeenth print scanning operations, shifting of the nozzles to be used toward the upstream side in the conveyance direction is performed as preliminary preparation for execution of the kicking-away operation. Specifically, the control of shifting the nozzles to be used toward the downstream side as described above is performed after the kicking-away operation. The nozzles to be used are shifted toward the upstream side in the conveyance direction in advance to prepare for this control. Note that, in the shifting of the nozzles to be used toward the upstream side before the kicking-away operation described herein, the print scanning operation in which the shifting is to be started is assumed to be determined in advance based on information on the size of the print medium set before the print start. Specifically, a rough trail edge position of the print medium is determined based on the information on the size of the print medium. Accordingly, the rough number of times of print scanning operations before the actual detection of the trailing edge by the PE sensor can also be determined. Note that, in practice, the position detected by the PE sensor may be different from the determined rough trail edge position, but the print scanning operation in which the shifting is to be started is determined to allow such difference.

After the start of the shifting performed from the twelfth print scanning operation in this example, the conveyance amount is reduced to an amount corresponding to one nozzle to shift the nozzles to be used toward the upstream side. Moreover, the region of nozzles to be used is made smaller by one nozzle every print scanning operation. This operation causes the band regions (band region L and beyond) in which the image printing starts in the twelfth print scanning operation and beyond to have a bandwidth of one nozzle, and can cause the region of nozzles to be used to become gradually smaller and allow nozzle shift to progress toward the upstream side in the conveyance direction. In the seventeenth print scanning operation, the nozzle shift to six nozzles (nozzles 6 to nozzle 11) on the upstream side in the conveyance direction is completed. Note that, in the process up to the completion of the nozzle shift before the kicking-away operation, the nozzles in charge of printing of each pass vary among the band regions. For example, in the band G, the printing of the sixth pass is performed by nozzle 1 and nozzle 2, in the band K, the printing of the sixth pass is performed by nozzle 5 and nozzle 6, and, in the band L, the printing of the sixth pass is performed only by nozzle 6. As described above, although the nozzles in charge of printing of each pass vary among the band regions, the nozzles in charge of printing of each pass for each band region are uniquely determined. Specifically, the nozzles to be used in the process up to the nozzle shift completion are uniquely determined.

The kicking-away operation is triggered by the detection of the trailing edge of the print medium by the PE sensor 206. The number of times of conveyance operations in a period from the detection of the trailing edge to the execution of the kicking-away operation is determined by the distance between the PE sensor 206 and the nip portion A and the conveyance amount in one conveyance operation. In the present embodiment, the kicking-away operation is assumed to be executed in the third conveyance operation after the conveyance operation in which the trailing edge is detected. In the example of FIG. 6, the trailing edge of the print medium is detected by the conveyance operation before the eighteenth print scanning operation and the kicking-away operation is executed in the conveyance operation before the twenty-first print scanning operation. In this example, the conveyance amount in the kicking-away operation is a conveyance mount corresponding to five nozzles and is four nozzles larger than the conveyance amount in the conveyance operation just before the kicking-away operation. Accordingly, in order to correct the print position, the nozzles to be used are shifted by −4 nozzles to set nozzles 2 to 7 that are downstream nozzles as the nozzles to be used and the twenty-first print scanning operation is executed. In the print scanning operations after the kicking-away operation, the printing proceeds while the conveyance of the print medium and the nozzle shift are performed such that the image printing can be performed to a most trailing edge of the print region with the print medium nipped by the downstream conveyance roller 202 and the auxiliary roller 203, and the image printing of the entire region is completed.

As described above, the timing of the trailing edge detection by the PE sensor 206 is not uniquely determined due to effects such as individual differences in print medium size. In other words, the timing of execution of the kicking-away operation is not uniquely determined due to the effects such as the individual differences in print medium size.

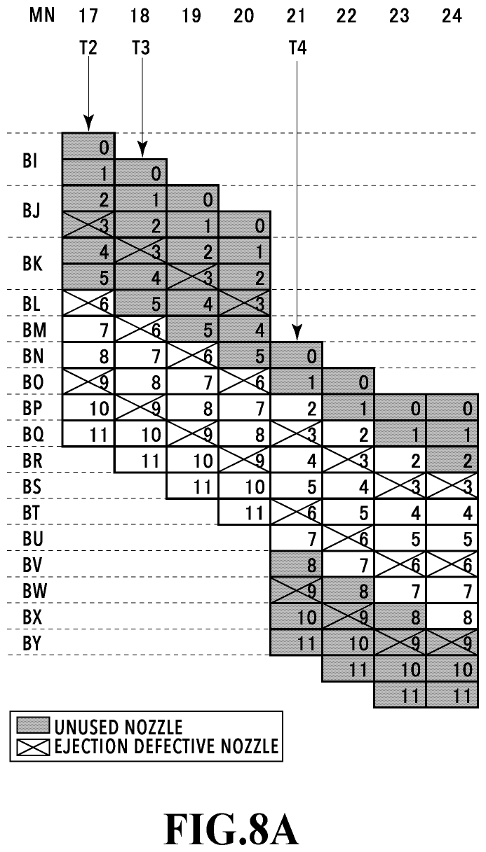

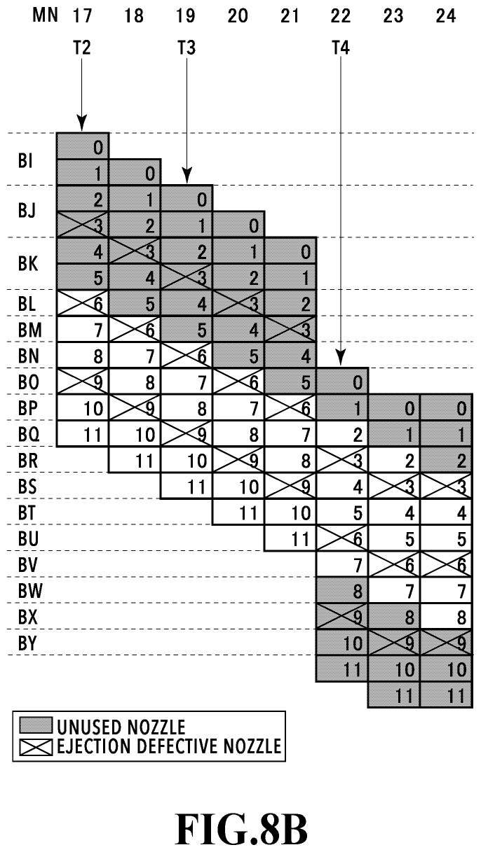

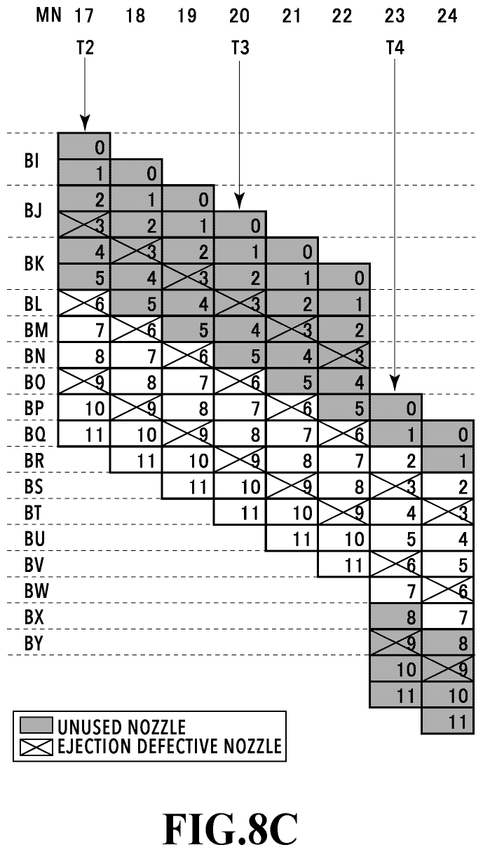

FIGS. 8A to 8C are diagrams illustrating the positions of the nozzles to be used and the positional relationship (conveyance amount of the print medium) of the print head relative to the print medium in each print scanning operation under each of three conditions varying in the timing of the trailing edge detection by the PE sensor 206. In FIGS. 8A to 8C, “MN” indicates “main scanning operation number.” “BI” to “BY” indicate “band region I” to “band region Y”, respectively. “T2” indicates “completion of nozzle shift before kicking-away.” “T3” indicates “trailing edge detection by PE sensor.” “T4” indicates “execution of kicking-away operation.” FIG. 8A illustrates an example in which the trailing edge of the print medium is detected by the conveyance operation before the eighteenth print scanning operation subsequent to the completion of the nozzle shifting before the kick-away as in FIG. 6. FIG. 8B illustrates an example in which the trailing edge of the print medium is detected in the first print scanning operation after that in FIG. 8A. FIG. 8C illustrates an example in which the trailing edge of the print medium is detected in the first print scanning operation after that in FIG. 8B. Focusing on the band region Q, the nozzles to be used in the respective passes pass vary depending on differences in the timing of the kicking-away operation. Specifically, in the case of FIG. 8A, nozzles 11, 10, 9, 8, 3, and 2 perform printing in this order from the first pass. In the case of FIG. 8B, nozzles 11, 10, 9, 8, 7, and 2 perform printing in this order from the first pass. In the case of FIG. 8C, nozzles 11, 10, 9, 8, 7, and 6 perform printing in this order from the first pass.

Effects of the ejection defective nozzles are described. In the present embodiment, nozzles 3, 6, and 9 are assumed to be the ejection defective nozzles (illustrated by x sign in FIGS. 8A to 8C). Focusing on the band region Q, in the case of FIG. 8A, the ejection defective nozzles perform printing of the third and fifth passes. As a result, the image printing in the band region Q is partially absent and image defect occurs. Similarly, in the case of FIG. 8B, the ejection defective nozzle performs printing of the third pass for the band region Q. As a result, the image printing in the band region Q is partially absent and image defect occurs. In the case of FIG. 8C, the ejection defective nozzles perform printing of the third and sixth passes for the band region Q. As a result, the image printing in the band region Q is partially absent and image defect occurs.

As described above, in the case where the kicking-away operation is executed based on the detection timing of the print medium trailing edge by the PE sensor 206, the nozzles in charge of printing in each region vary depending on the trailing edge detection timing. Focusing on the band region Q again, the PE sensor 206 detects no trailing edge in the print scanning operation of the first pass (seventeenth print scanning operation). Thereafter, the PE sensor 206 detects the trailing edge in the state where the print scanning operations of the passes for the band region Q are already partially completed. In this trailing edge detection, the trailing edge is detected at various timings depending on the print medium and the nozzles to be used also vary depending on the timing of the trailing edge detection by the PE sensor 206. Specifically, whether each region includes a pass in which the ejection defective nozzle performs printing or not is unclear at the moment of the print scanning operation of the first pass for the region. Moreover, in the case where the region includes a pass in which the ejection defective nozzle performs printing as described above, whether the nozzles to perform printing of the other passes are determined or not is unclear. Accordingly, there is a possibility that a preferable process cannot be executed in a publicly known mask pattern correction (non-ejection complementary processing) method.

### <Non-Ejection Complementary Processing>

Description is given below of an example in which the non-ejection complementary processing is preferably performed also in the case as described above. In the present embodiment, description is given of an example in which the mask patterns are divided into multiple mask groups in the mask pattern correction and then mask pattern correction is performed for each of the divided mask groups based on information indicating the ejection defective nozzles to reduce the image defect.

The non-ejection complementary processing of the present embodiment is described by focusing on the band region Q of FIGS. 8A to 8C again. First, dividing to mask groups is described. The mask patterns are divided into two groups by setting masks corresponding to the first three passes in the six-pass printing as a first mask group and setting masks corresponding to the last three passes as a second mask group.

As described above, the nozzles in charge of printing in each band region are not uniquely determined in a portion around the trailing edge detection by the PE sensor 206 due to differences in the trailing edge detection timing by the PE sensor 206. However, in the example of the present embodiment, as described above, the predetermined number (three in this example) of the conveyance operations are configured to be interposed between the trailing edge detection by the PE sensor 206 and the execution of the kicking-away operation. In other words, the nozzles to be used in the next three print scanning operations from the concerned print scanning operation are determined irrespective of a trailing edge detection status in printing of any region in the conveyance direction. For example, description is given by using the example of FIG. 8A. In the band region Q, the PE sensor 206 detects the trailing edge before the print scanning operation of the second pass, but at least nozzles 11, 10, and 9 to be used in the first to third passes are determined before the print scanning operation of the first pass. In the band region R, the PE sensor 206 detects the trailing edge before the print scanning operation of the first pass, but at least nozzles 11, 10, and 9 to be used in the first to third passes are determined before the print scanning operation of the first pass. This is because three conveyance operations are configured to be interposed between the trailing edge detection by the PE sensor 206 and the execution of the kicking-away operation as described above. In the band region S, the PE sensor 206 has already detected the trailing edge before the print scanning operation of the first pass and the print scanning operation in which the kicking-away operation is to be performed is determined. Accordingly, at least nozzles 11, 10, and 5 to be used in the first to third passes are determined before the print scanning operation of the first pass. This is because, in the band region S, execution of nozzle shift of four nozzles is determined in the twenty-first print scanning operation corresponding to the print scanning operation of the third pass as described above.

As described above, in the predetermined number (three in this example) of print scanning operations corresponding to the known conveyance operations in the period from the trailing edge detection of the PE sensor 206 to the execution of the kicking-away operation, the nozzles to be used are determined at a point before the print scanning operation of the first pass irrespective of the trailing edge detection status. Accordingly, also in a band region in which printing is to be newly started, the nozzles in charge of printing of the first three passes are determined at the point before the print scanning operation of the first pass for the concerned band region. The mask pattern correction is thus performed in the first three passes, that is in the first mask group.

Meanwhile, in the portion around the trailing edge detection by the PE sensor 206, the nozzles in charge of the last three passes for each band region are not determined at the point of the start of printing of the first pass. Accordingly, in the mask pattern correction of the second mask group corresponding to the last three passes, the timing of correction is set before start of the print scanning operation of the fourth pass for the concerned band region. Since the nozzles to be used in the next three print scanning operations are determined as described above, the nozzles in charge of printing up to the sixth pass are determined at a point of the start of the print scanning operation of the fourth pass. For example, description is given by using the example of FIG. 8C. In the band region Q, the PE sensor 206 detects the trailing edge before the print scanning operation of the fourth pass, but at least nozzles 8, 7, and 6 to be used in the fourth to sixth passes are determined before the print scanning operation of the fourth pass. This is because three conveyance operations are configured to be interposed between the trailing edge detection by the PE sensor 206 and the execution of the kicking-away operation as described above. In the band region R, the PE sensor 206 detects the trailing edge before the print scanning operation of the third pass that is before the print scanning operation of the fourth pass. Accordingly, in the case where the interposing of the three conveyance operations between the trailing edge detection by the PE sensor 206 and the execution of the kicking-away operation is taken into consideration, nozzles 8, 7, and 2 to be used in the fourth to sixth passes are determined before the print scanning operation of the fourth pass. Since the nozzles to be used in the next three print scanning operations are determined as described above, the nozzles in charge of printing up to the sixth pass are determined at the point of the start of the print scanning operation of the fourth pass. Accordingly, it is possible to execute mask pattern correction in the second mask group.

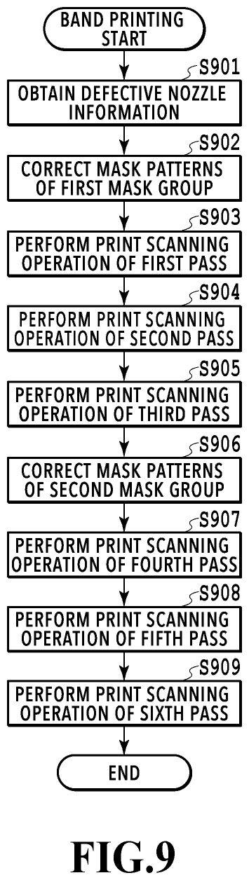

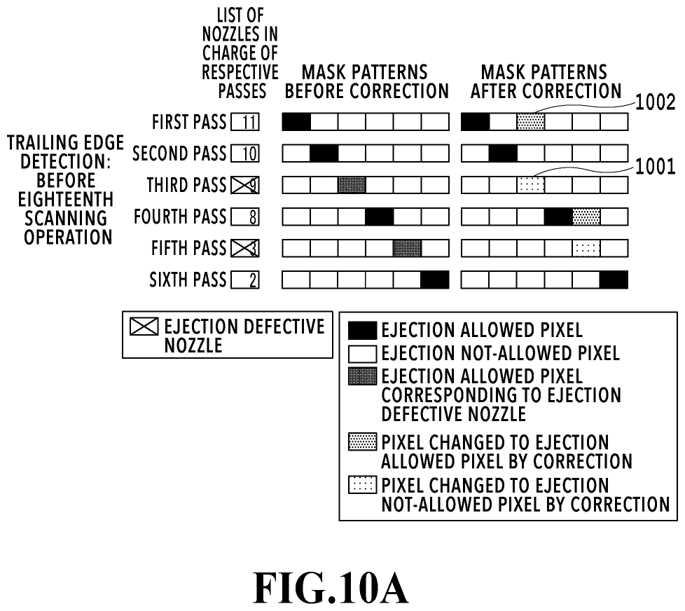

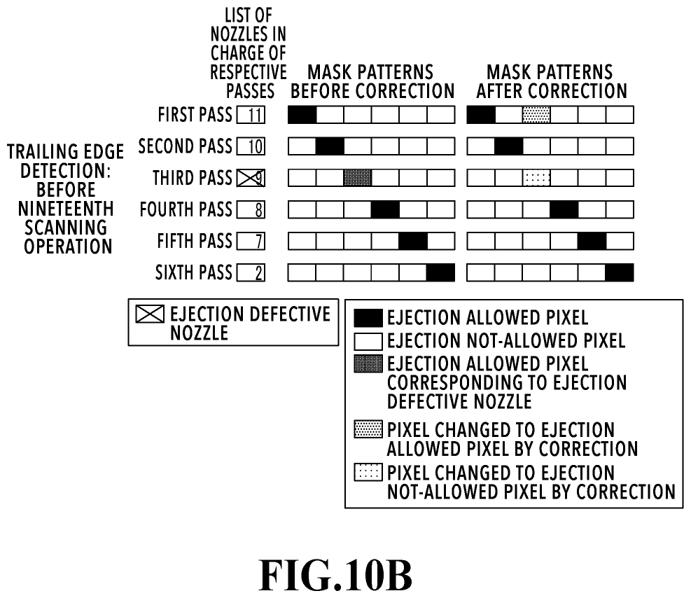

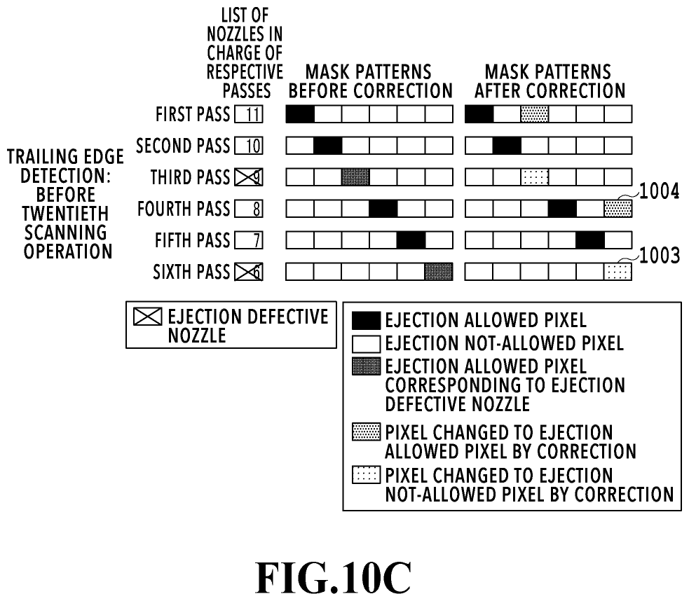

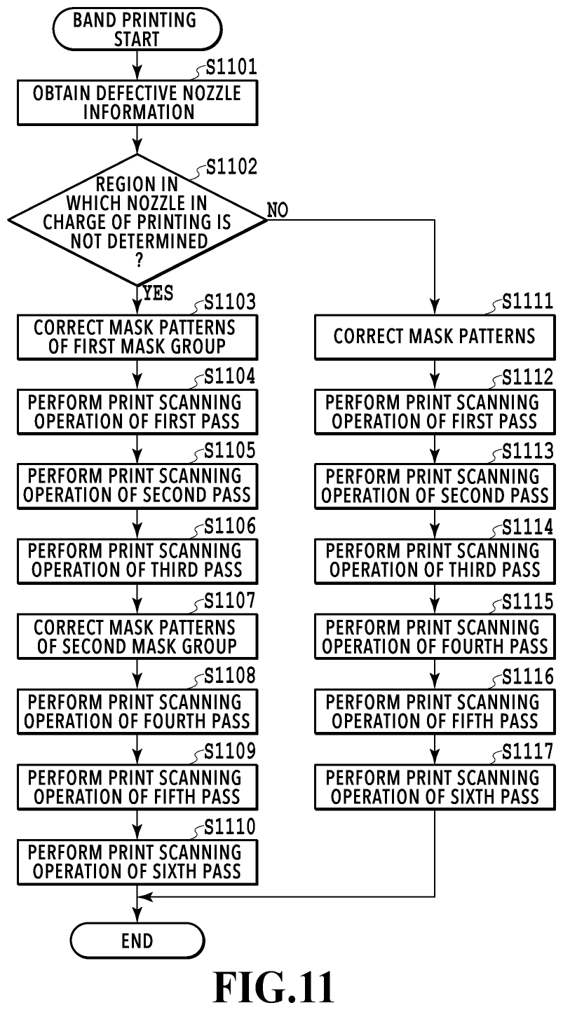

Details of the mask pattern correction are described by using FIGS. 9 to 10C. FIG. 9 is a flowchart illustrating an example of print control in printing of one band region. FIGS. 10A to 10C are each a diagram explaining the mask pattern correction while focusing on the band region Q. FIGS. 10A to 10C each illustrate information on the nozzles in charge of printing of the respective passes, mask patterns before the correction, and mask patterns after the correction. FIGS. 10A to 10C correspond to FIGS. 8A to 8C, respectively, and illustrate cases varying in the trailing edge detection timing by the PE sensor 206.

The CPU 109 of the print control unit 101 loads a program code stored in the ROM 505 onto the RAM 506 and executes the program code to execute the flowchart illustrated in FIG. 9. Alternatively, hardware such as an ASIC or an electronic circuit may implement functions of some or all of the steps in FIG. 9. Note that sign “S” in the description of processes means step in the flowchart. Moreover, the flowchart illustrated in FIG. 9 illustrates an example of print control in which only one print band region is printed. Accordingly, in printing of multiple band regions, the control illustrated in FIG. 9 is performed such that controls for the respective band regions are performed in parallel while being shifted from one another.

In S901, the print control unit 101 reads the ejection defective nozzle data 503 stored in the memory 110 and obtains information (hereinafter, referred to as defective nozzle information) specifying the nozzles in which ink ejection defect is present. In the present embodiment, it is assumed that the print control unit 101 obtains the defective nozzle information indicating that nozzles 3, 6, and 9 are the ejection defective nozzles as described above. Note that the ejection defective nozzle data can be generated by various methods. For example, there may be employed a method in which information indicating the defective nozzles determined in manufacturing of the print head 111 is saved in a memory provided in the print head 111 and the ejection defective nozzle data is updated by using this information. Moreover, there may be employed a method in which: a test pattern is printed; the ejection defective nozzles are determined based on the test pattern; and the ejection defective nozzle data is updated. Moreover, the method may be such that the printing apparatus 100 is provided with a detection mechanism that detects an ejection state of the print head 111 and the ejection defective nozzle data is updated based on a detection result. The method of generating the ejection defective nozzle data is not limited to those described above. Note that, in the present embodiment, data stored in the memory 110 is referred to as ejection defective nozzle data and description is given of an example in which the defective nozzle information is obtained based on the ejection defective nozzle data. However, the defective nozzle information may be stored in the memory 110.

In S902, the print control unit 101 corrects the mask patterns of the first mask group corresponding to the first three passes. The timing of executing the process of S902 is before execution of the print scanning operation (seventeenth in the case of the band region Q) of the first pass for the concerned band region. The mask patterns are corrected by using the defective nozzle information obtained in S901 and in-charge nozzle information indicating in-charge nozzles in charge of printing of the first three passes. As described above, in the present embodiment, since the first three passes are included in the next three print scanning operations from a point before the print scanning operation of the first pass (that is at a point of start of the process of this flowchart), the nozzles in charge of printing are determined. For the band region Q, there is obtained the in-charge nozzle information indicating that the nozzle in charge of the printing of the first pass is nozzle 11, the nozzle in charge of the printing of the second pass is nozzle 10, and the nozzle in charge of the printing of the third pass is nozzle 9. In this case, as illustrated in FIGS. 10A to 10C, nozzle 9 that is the ejection defective nozzle is in charge of the printing of the third pass. Accordingly, in S902, the print control unit 101 changes a pixel 1001 of the mask region which nozzle 9 is in charge of, to an ejection not-allowed pixel and changes a pixel 1002 in the first pass for which normal printing can be performed, to an ejection allowed pixel. The correction of the first mask group corresponding to the first three passes is completed by the mask pattern correction described above. Correcting the mask patterns as described above causes the printing of the pixel 1002 to be performed in the first pass by using nozzle 11 that can perform normal printing.

Although the first pass is set as a correction destination in the present embodiment, the present invention is not necessarily limited to this and the second pass may be selected. Moreover, it is possible to increase the horizontal size of the mask patterns and change the correction destination for each pixel to be corrected.

From S903 to S905, the print control unit 101 sequentially performs the printing of the first pass to the third pass. Performing printing while thinning the image by using the mask patterns corrected in S902 enables normal printing of the image up to the third pass without an absent portion in the image.

In S906, the print control unit 101 corrects the mask patterns of the second mask group corresponding to the last three passes. The timing of executing the process of S906 is before execution of the print scanning operation (twentieth in the case of the band region Q) of the fourth pass for the concerned band region. In S906, the mask patterns are corrected by using the defective nozzle information obtained in S901 and the in-charge nozzle information indicating nozzles in charge of printing of the last three passes. As described above, since the fourth to sixth passes are included in the next three print scanning operations from the point of the process, the nozzles in charge of printing are determined. One of FIGS. 10A to 10C is obtained as the in-charge nozzle information depending on the trailing edge detection timing by the PE sensor 206. For example, in the case where the trailing edge detection occurs in the conveyance operation before the twentieth print scanning operation as in FIG. 10C, there is obtained the in-charge nozzle information indicating that nozzle 8 is in charge of the fourth pass, nozzle 7 is in charge of the fifth pass, and nozzle 6 is in charge of the sixth pass for the band region Q. In this case, since nozzle 6 that is the ejection defective nozzle is in charge of the sixth pass, the print control unit 101 changes a pixel 1003 of the corresponding mask region to the ejection not-allowed pixel and changes a pixel 1004 in the fourth pass for which normal printing can be performed to the ejection allowed pixel. Although the fourth pass is set as the correction destination in this example, the present invention is not necessarily limited to this as described above. The correction of the second mask group corresponding to the last three passes is completed by the mask pattern correction described above. Note that similar mask pattern correction is performed also in the case where the trailing edge detection is as in FIG. 10A. In the case where the trailing edge detection is as in FIG. 10B, the in-charge nozzle information includes no defective nozzles. Accordingly, the mask pattern correction does not have to be performed.

From S907 to S909, the print control unit 101 sequentially performs the printing of the fourth pass to the sixth pass. Performing printing while thinning the image by using the mask patterns corrected in S906 enables normal printing of the image from the fourth pass to the sixth pass without an absent portion in the image.

As illustrated in FIGS. 10A to 10C, the corrected mask patterns corresponding respectively to the first three passes and the last three passes maintain a complementary relationship with one another. Accordingly, all pixels are printed by laying images printed in six passes one on top of the other.

As described above, in the present embodiment, the control of detecting the trailing edge of the print medium with the PE sensor and determining the timing of the kicking-away operation is performed. In such control, whether the printing of a certain band region involves the ejection defective nozzle or not is not determined at the point of the printing of the first pass for the band region. Moreover, also in the case where the printing of the band region involves the ejection defective nozzle, the nozzles used to print the band region are not determined. Even in such a case, in the present embodiment, the mask patterns are divided into two mask groups and the mask pattern correction process executed for each of the divided mask groups while varying the process timing of the correction process. The mask patterns can be thereby appropriately corrected. As a result, the non-ejection complementary processing can be appropriately performed. Specifically, even in the case where the nozzles to be used are not determined at the point of the printing of the first pass for the band region, the mask data indicating the mask patterns can be appropriately corrected. This can reduce dot misalignment due to a conveyance error and an image defect to printing absence due to printing using the ejection defective nozzle.

### Second Embodiment

In the present embodiment, description is given of an example in which regions where the mask patterns are to be corrected by being divided into mask groups are limited to some regions and the correction is executed. As described above, a portion in which the nozzles in charge of printing in each band region are not determined is limited only to the portion around the trailing edge detection by the PE sensor. In other words, in regions from the leading edge of the print medium to a position just before the portion around the trailing edge detection and in regions in which printing starts after the trailing edge detection, the nozzles in charge of printing are uniquely determined. In these regions in which the nozzles in charge of printing are determined, it is possible to correct the mask patterns without dividing the mask patterns into mask groups. Moreover, in the case where the mask patterns are not divided into mask groups, mask pixels changed to the ejection allowed pixels to substitute mask pixels corresponding to the ejection defective nozzles can be distributed to more passes than in the case where the mask patterns are divided into mask groups. In other words, it is possible to reduce the case where the number of times of ejection increases only in a certain nozzle and reduce an effect on the durability of the print head. Accordingly, in the present embodiment, description is given of an example in which the print control described in the first embodiment is executed while being limited to some regions. Moreover, description is given of an example in which the mask patterns are corrected while not being divided into mask groups in regions other than the some regions.

FIG. 11 is a flowchart of printing of one band region in the present embodiment. In S1101, the print control unit 101 reads the ejection defective nozzle data stored in the memory 110 and obtains the defective nozzle information.

In S1102, the print control unit 101 determines whether a not-determined nozzle is present in the nozzles in charge of printing for the concerned band region. Specifically, the print control unit 101 checks the nozzles in charge of printing of the first to sixth passes for the concerned band region. Then, in the case where at least one not-determined nozzle is present, the process proceeds to S1103. In the case where all nozzles are determined, the process proceeds to S1111. Note that, whether the not-determined nozzle is present or not may be determined depending on, for example, whether the nozzle shift before the kicking-away is completed or not. This is because the nozzle shift before the kicking-away is controlled to be completed before the trailing edge detection by the PE sensor 206 as described in the first embodiment. Moreover, also in the case where the trailing edge detection by the PE sensor 206 has already occurred, the print control unit 101 can determine that all nozzles are determined.

In the case where the not-determined nozzle is present, the print control unit 101 corrects the mask patterns of the first mask group and performs the printing of the first to third passes in S1103 to S1106 as in the first embodiment. Moreover, the print control unit 101 corrects the mask patterns of the second mask group, sequentially performs the printing of the fourth to sixth passes, and completes the printing for the concerned band region in S1107 to S1110. These processes are the same processes as S902 to S909 in FIG. 9.

Meanwhile, in the case where the not-determined nozzle is absent, in S1111, the print control unit 101 corrects the mask patterns. In the correction, the print control unit 101 does not divide the mask patterns into mask groups, and corrects the mask patterns based on the in-charge nozzle information on the nozzles in charge of the printing of the first to sixth passes and the defective nozzle information obtained in S1101. The print control unit 101 changes mask pixels corresponding to the ejection defective nozzles to the ejection not-allowed pixels and changes mask pixels in other passes for which normal printing can be performed to the ejection allowed pixels. In this case, the number of correction destinations is larger than that in the case where the mask group dividing is performed. Accordingly, the case where the number of times of ejection increases only in a certain nozzle can be suppressed by distributing the correction destinations to mask pixels corresponding to multiple nozzles.

In S1112 to S1117, the print control unit 101 sequentially performs the printing of the first pass to the sixth pass based on the corrected mask patterns and completes the printing of the concerned band region.

As described above, according to the present embodiment, limiting the regions where the mask patterns are corrected by being divided into mask groups can suppress image defects by appropriate mask pattern correction. Moreover, it is possible to further suppress the case where the number of times of ejection increases in a certain nozzle and further suppress an effect on the durability of the print head from the first embodiment.

### OTHER EMBODIMENTS

Although the example in which the mask patterns are divided such that the numbers of passes corresponding to the respective mask groups are equal in the aforementioned embodiment, the present invention is not limited to this example. One mask group may correspond to more passes than the other as long as each mask group corresponds to two or more passes. Moreover, the number of divided mask groups is not limited to two and may be three or more. For example, assume that the number of print scanning operations corresponding to the conveyance operations in the period from the trailing edge detection by the PE sensor 206 to the execution of the kicking-away operation is three as in the aforementioned embodiments. Moreover, assume that printing for a predetermined unit region completes in eight passes. In this case, the nozzles to be used in the next three print scanning operations from the concerned print scanning operation are determined irrespective of the trailing edge detection status in printing of any region in the conveyance direction. Accordingly, the nozzles to be used in the first to third passes are determined at a point before the start of the print scanning operation of the first pass. Moreover, the nozzles to be used in the fourth to sixth passes are determined at a point before the start of the print scanning operation of the fourth pass. Furthermore, the nozzles to be used for the seventh and eighth passes are determined at a point before the start of the print scanning operation of the seventh pass. Accordingly, the mask patterns can be divided into three mask groups of a group of the first to third passes, a group of the fourth to sixth passes, and a group of the seventh to eighth passes. As described above, the number of corresponding passes may vary among the divided mask groups.

Moreover, the number of passes is not limited to six passes or eight passes described above. The present invention can be applied to a mode in which print control of printing an image is performed by performing N (N is an integer of four or more) print scanning operations of the print head for a unit region of the print medium by using N mask patterns used for the N print scanning operations. In such a mode, it is only necessary to divide the N mask patterns into mask groups each corresponding to two or more print scanning operations and correct the mask patterns in each divided mask group based on the defective nozzle information.

Moreover, in the second embodiment, whether the mask patterns are to be corrected by being divided into mask groups is determined based on whether the not-determined nozzle is present in the nozzles in charge of printing of the concerned band region. However, switching between dividing and not-dividing may be performed depending on, for example, a position in the conveyance direction of the print medium.

Moreover, the present invention can be also applied to the case where printing is performed while the image data is thinned in unit of columns to perform high-speed printing. For example, it is only necessary to divide the mask patterns corresponding to printing of image data of the unit of columns into mask groups and correct the mask patterns.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2021-065728, filed Apr. 8, 2021, which is hereby incorporated by reference wherein in its entirety.

What is claimed is:

1. An inkjet printing apparatus comprising:
a conveyance unit configured to convey a print medium in a conveyance direction;
a print head configured to have a nozzle row in which nozzles configured to eject ink are arranged in the conveyance direction;
a detection unit configured to detect a trailing edge of the print medium conveyed by the conveyance unit;
a control unit configured to print an image by controlling a usage range of the nozzle row in the conveyance direction and a conveyance amount of the print medium after detection of the trailing edge, based on a detection result of the detection unit, the image printed in N (N is an integer of four or more) print scanning operations of the print head for a unit region of the print medium by using N mask patterns used in the N print scanning operations;
an obtaining unit configured to obtain defective nozzle information specifying a defective nozzle; and
a correction unit configured to divide the N mask patterns into mask groups each corresponding to two or more print scanning operations and correct the mask patterns based on the defective nozzle information in each of the divided mask groups.

2. The inkjet printing apparatus according to claim 1, wherein the correction unit causes a timing of correction of the mask patterns to vary between the mask groups.

3. The inkjet printing apparatus according to claim 1, wherein a timing of correction of the mask patterns in at least one of the mask groups is after start of printing in a partial region in the unit region by using the mask patterns of another mask group.

4. The inkjet printing apparatus according to claim 1, wherein the correction unit performs the process of dividing and correcting the mask patterns, on the mask patterns corresponding to printing of a certain region in a print region of the print medium.

5. The inkjet printing apparatus according to claim 4, wherein the certain region is a region of a predetermined range that extends downstream, in the conveyance direction, from a print scanning portion in which there is a possibility that the detection unit detects the trailing edge of the print medium.

6. The inkjet printing apparatus according to claim 5, wherein the certain region is larger than the unit region.

7. The inkjet printing apparatus according to claim 4, wherein, in printing of a region other than the certain region, the correction unit corrects the mask patterns based on the defective nozzle information without dividing the mask patterns into the mask groups.

8. The inkjet printing apparatus according to claim 1, wherein the correction unit corrects the mask patterns in unit of the unit region.

9. The inkjet printing apparatus according to claim 1, wherein the control unit performs conveyance for a predetermined number of print scanning operations from detection of the trailing edge by a first conveyance amount and then conveys the print medium by a second conveyance amount larger than the first conveyance amount.

10. The inkjet printing apparatus according to claim 9, wherein the correction unit divides the mask patterns based on the predetermined number.

11. A printing method of an inkjet printing apparatus including:
a conveyance unit configured to convey a print medium in a conveyance direction;
a print head configured to have a nozzle row in which nozzles configured to eject ink are arranged in the conveyance direction;
a detection unit configured to detect a trailing edge of the print medium conveyed by the conveyance unit; and
a control unit configured to print an image by controlling a usage range of the nozzle row in the conveyance direction and a conveyance amount of the print medium after detection of the trailing edge, based on a detection result of the detection unit, the image printed in N (N is an integer of four or more) print scanning operations of the print head for a unit region of the print medium by using N mask patterns used in the N print scanning operations, the printing method comprising:
obtaining defective nozzle information specifying a defective nozzle; and
dividing the N mask patterns into mask groups each corresponding to two or more print scanning operations and correcting the mask patterns based on the defective nozzle information in each of the divided mask groups.
